(19) United States
(12) Patent Application Publication
(10) Pub. No.: US 2016/0257162 A1
(43) Pub. Date: Sep. 8, 2016

(54) DRY ERASE BOARD HAVING THREE-DIMENSIONAL MARKING SURFACE

(71) Applicant: David Cruickshank, New Britain, CT (US)

(72) Inventor: David Cruickshank, New Britain, CT (US)

(21) Appl. No.: 14/837,901

(22) Filed: Aug. 27, 2015

Related U.S. Application Data
(60) Provisional application No. 62/029,058, filed on Jul. 25, 2014.

(51) Int. Cl. B43L 1/00; B29C 51/10

(52) U.S. Cl. CPC B43L 1/00; B29C 51/10; B29L 2031/722

(57) ABSTRACT

A three-dimensional dry erase board is fabricated in a vacuum forming process using a suitable thermoplastic material laid over a mold of any desired three-dimensional surface. The three-dimensional dry erase board can be fashioned into any three-dimensional surface, with it replicating well-known persons, objects, logos, scenery, or the like. The dry erase board retains its markable and erasable qualities of the three-dimensional surface.

### CROSS REFERENCE TO RELATED APPLICATIONS

This application is entitled to the benefit of and incorporates by reference essential subject matter disclosed in Provisional U.S. Application 62/029,058 filed Jul. 25, 2014.

### BACKGROUND OF THE INVENTION

Humans have been seeking methods for communicating amongst themselves since Adam met Eve. Of course direct face-to-face communication is usually preferred, but other methods were sought when such a physical meeting could not take place. Thus ‘message boards’ and ‘letters’ were created. The first most likely being a stick drawing in dirt, or a clever arrangement of stones on the ground, Soon more sophisticated methods were invented such as Moses' stone tablets the Egyptian scroll. Eventually the modern printed billboard was invented around the time of the US Civil War.

Flat dry erasable message boards are a relatively new invention and method for communicating. Their precursor was the “whiteboard” invented in the late 50's. Used in classroom and meetings, the whiteboard brought the concept of a markable/eraseable flat surface to extensive use. Originally a clear film was scrolled across a white surface and such film could be wound on to a takeup roller as a new clear section of film was presented for marking. Eventually the film sheet was removed and an enameled white sheet was used to mark on. It was scratch resistant and easy to erase and clean. From this technology came the personal dry erase board found in many stores today. IVs a smaller size board you can hang in your kitchen for messaging the family.

### FIELD OF INVENTION

This invention relates to methods and equipment for communicating or entertaining through a visual arts medium and more particularly to a new and novel dry erase board having a three-dimensional surface for eraseably receiving and displaying messages, logos, and artistic drawings applied to the surface by standard dry erase markers.

### BRIEF SUMMARY OF THE INVENTION

The invention in a first embodiment consists of a sheet of dry eraseable plastic material that has been permanently deformed into a three-dimensional surface.

The shape of the three-dimensional surface can replicate any known person, object, animal, place, logo, text, arbitrary shape or combination thereof. The limits of the three-dimensional surface are limited only by the creator's imagination.

### BRIEF DESCRIPTION OF THE DRAWINGS

FIG. 1 is a front perspective view of the three-dimensional dry erase board in a first embodiment of the invention;

FIG. 2 is a front view of the three-dimensional dry erase board;

FIG. 3is a left elevation side view of the three-dimensional dry erase board;

FIG. 4 is a right elevation side view of the three-dimensional dry erase board;

FIG. 5 is a top view of the three-dimensional dry erase board;

FIG. 6 is a bottom view of the three-dimensional dry erase board;

FIG. 7 is a perspective view of the master mold used in the process of fabricating the three-dimensional dry erase board;

FIG. 8 is a perspective view of one of the individual molds in the master mold used in the process of fabricating the three-dimensional dry erase board;

FIG. 9 is a perspective view of the vacuum forming machine used in the process of fabricating the three-dimensional dry erase board; and

FIG. 10 is a perspective view of the master mold used in the process of fabricating the three-dimensional dry erase board.

### DETAILED DESCRIPTION OF THE INVENTION

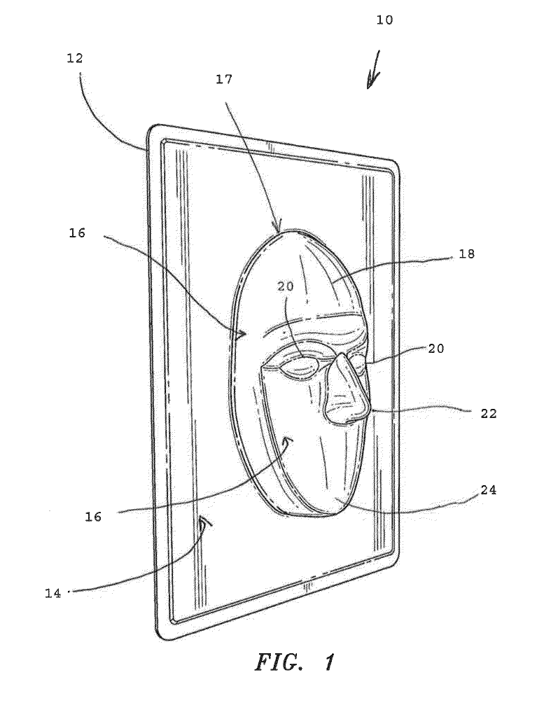

Now referring to FIG. 1 a perspective view of the three-dimensional dry erase board 10 in a first embodiment of the invention is shown. The invention 10 is fabricated through a vacuum mold process using PETG (polyethylene terephthalate glycol) polyester plastic resulting in the three dimensional sheet shown in FIG. 1. Other suitable materials may be used. The molding process will be described below. The resultant three-dimensional dry erase board 10 has a rectangle edge 12 for its border.

A flat surface 14 of the invention 10 surrounds the three-dimensional relief surface 16. In approximately the center of the invention 10 a humanoid face 17 protrudes upward from the flat surface 14. The face 17 comprises a forehead 18, a pair of eyes 20, a nose 22, and a nondescript mouth/chin area 24.

The entire invention 10 from the rectangular edge 12 to the nose 22 may be drawn on with dry erasable markers (not shown) wherein such markers may be of any color. This allows a person a wide spectrum of artistic creativity.

The artistic creations are produced by drawing on the three-dimensional features comprising the face 17 with erasable markers to add dimension and character to the face. For example, the drawing may include adding eyelashes, ears, bowties, hairdos and so on depending on the three-dimensional features. The choices are endless and may include a child's artwork, political commentary, comedy, purely informational messages and any other theme. Since the drawing on the erase board 10 with erasable markers is erasable, after a first artistic creation is produced on the board, it can be erased and a second creation can be drawn. The process can be repeatedly indefinitely.

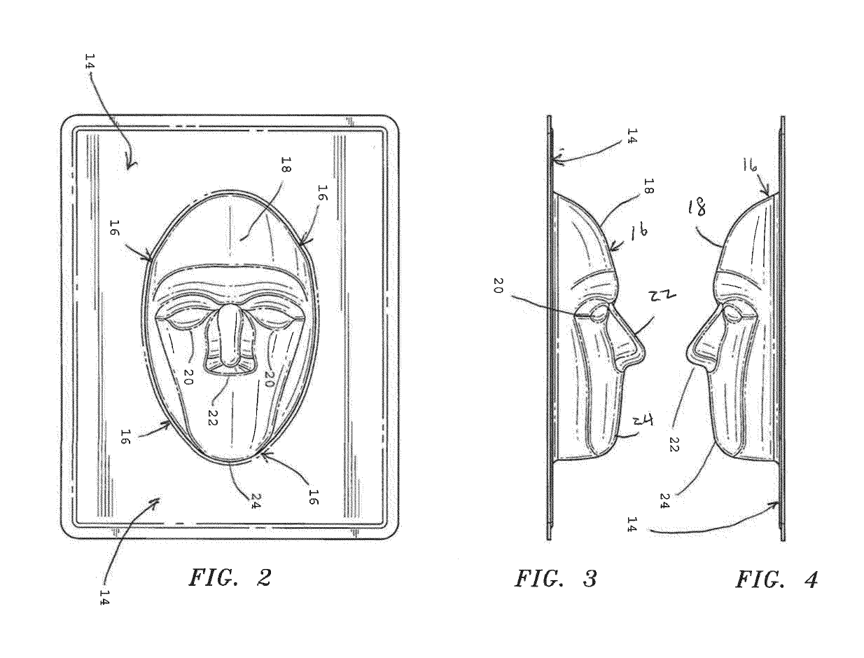

FIG. 2 shows a front view of the invention 10. The flat surface 14 again surrounds the relief surface 16 comprising a humanoid face which protrudes upward from the flat surface 14. The face comprises a forehead 18, a pair of eyes 20, a nose 22, and a nondescript mouth/chin area 24.

FIG. 3 shows a left side view of the invention 10. The flat surface 14 again surrounds the relief surface 16 comprising a humanoid face which protrudes upward from the flat surface 14. The face comprises a forehead 18, a pair of eyes 20, a nose 22, and a nondescript mouth/chin area 24.

FIG. 4 shows a right side view of the invention 10. This view is essentially identical to FIG. 3 due to the symmetry of the invention 10 about a vertical plane bisecting the invention 10 through the nose 22 in a manner perpendicular to the flat plate 14. However, symmetry of the relief surface 16 is not an essential feature of the invention.

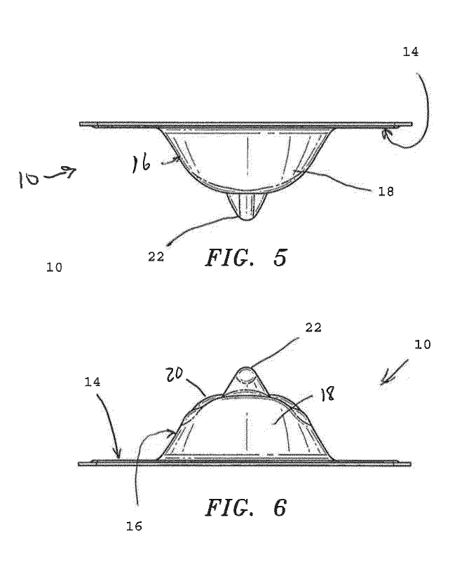

FIG. 5 shows a top view of the invention 10. The humanoid face protrudes from a flat surface 14. In this view the forehead 18 and the nose 22 can be seen.

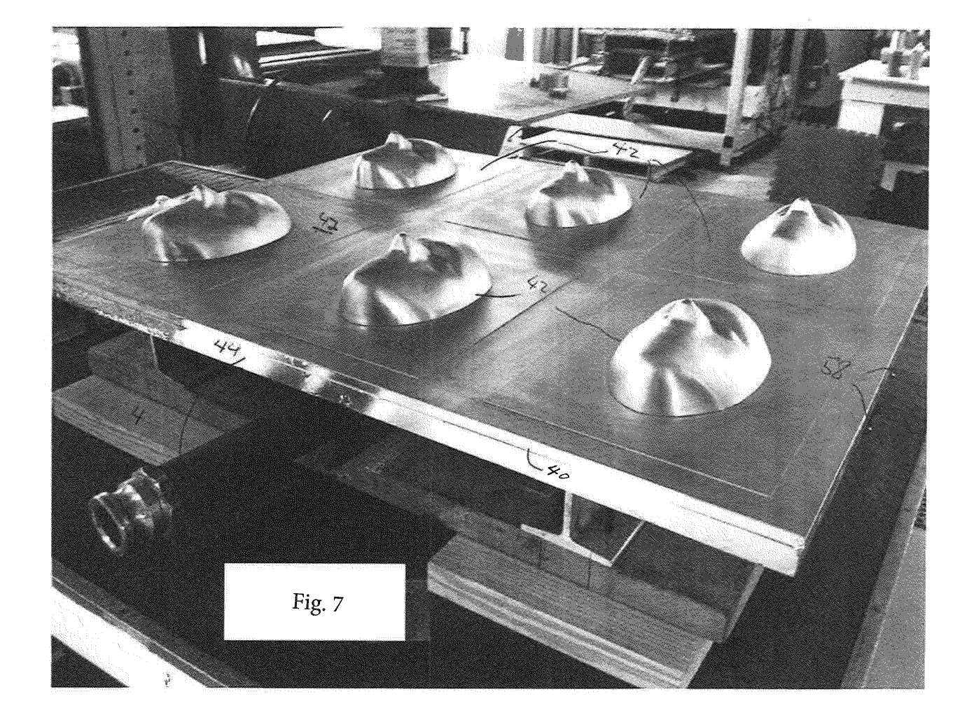

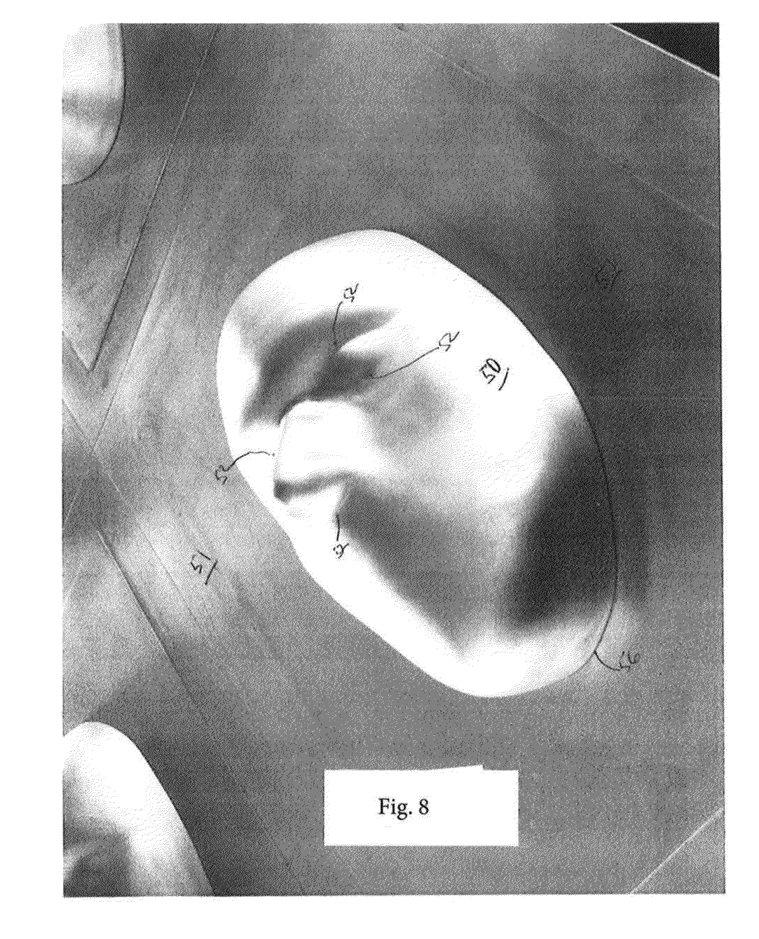

FIG. 6 shows a bottom view of the invention 10. The humanoid face 17 protrudes from the flat surface 14. In this view the nose 22 and the nondescription mouth/chin area 24 can be seen.

It should be noted that all of the surfaces visible in FIGS. 1-6 possess a dry erasable surface that can be drawn or marked on with a dry erasable marker of any color.

### Vacuum Forming Process

The vacuum forming process used to fabricate the three-dimensional dry erase board 10 consists of first fabricating a master mold 40 as shown in FIG. 7. The mold is comprised of a face mold made in a conventional manner and then mounted to the master mold sheet. A warm sheet of thermoplastic material is laid over the master mold and pulled down by vacuum forces to form the sheet to the mold. Cooling is provided to the master mold by cold-water circuits. For example, a sheet of PETG thermoplastic is heated to a pliable state, for example, 125° F., over the master mold so as to be pliable and then pulled down on the mold by vacuum. Cooling water then is circulated through the mold to cool and set the thermoplastic sheet in a rigid state.

FIG. 7 is a perspective view of the master mold 40. Six individual molds 42 are combined onto master mold 40 for production efficiency. A master vacuum port 44 will be coupled to a vacuum source during the production phase to assist in the vacuum forming process by pulling the thermoplastic sheet down onto the master mold 40. A cold water circuit inside the master mold 40 has intake and exhaust ports 58 located on the side of the master mold 40. These ports 58 are coupled to a cold water source during production and provide the necessary cold sink during the final stages of production when the thermoplastic sheet must be cooled.

FIG. 8 is a perspective view of one of the six individual molds 42 that make up the master mold 40 in FIG. 7. The face mold 50 has been mounted on the flat sheet 51 and a series of mini-vacuum ports are manufactured into the face mold 50, the flat sheet 51, and the gap 56 between them. The face mold 50 has a series of small holes 52 located in critical valley points of the face mold 50, such as the base of the nose, the top of the nose, and several points around the eyes. These small holes 52 are critical as they ensure the thermoplastic sheet is sufficiently pulled and deformed into these areas to provide an exact three-dimensional replication of the facial mold surface. A further series of mini vacuum ports 52 are located around the edge of the flat sheet 51. This ensures that the plastic sheet is sufficiently pulled and deformed down onto the surface. Also the face mold 50 is mounted in a slightly elevated position from the flat sheet 51 creating an open scene 56 between the face old 50 and a flat sheet 51. This ensures that the thermoplastic sheet is sufficiently pulled down around the face mold 50.

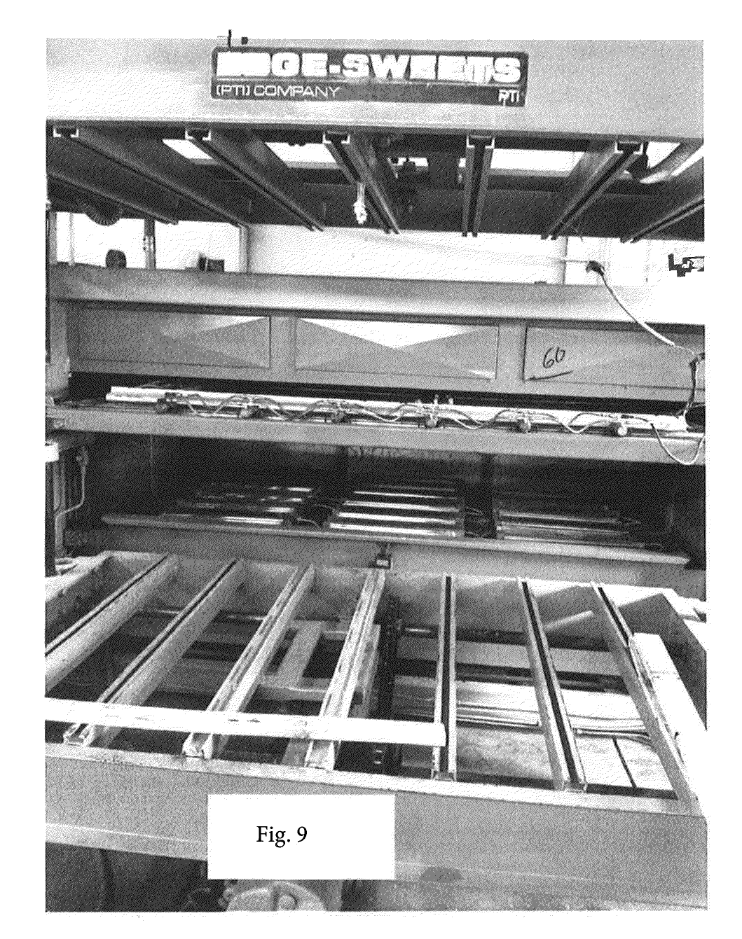

FIG. 9 is a perspective view of the vacuum formatting machine 60. In this machine 60 the thermoplastic sheet is heated to the appropriate temperature so that the material becomes very pliable. The master mold 40 is placed on a rack below a second rack, which holds the thermoplastic sheet. When the thermoplastic sheet reaches the correct temperature the sheet is lowered onto the master mold 40. A vacuum source is then applied to the master mold 40 pulling and deforming the thermoplastic sheet onto the contours of the master mold 40. When the thermoplastic sheet has completely formed to the contours of the master mold 40, a cold water cooling circuit is activated in the master mold 40 to cool the thermoplastic sheet. Once the thermoplastic sheet has been sufficiently cooled, it regains its rigid characteristics and the sheet is removed for cutting into the six individual three-dimensional dry erase boards.

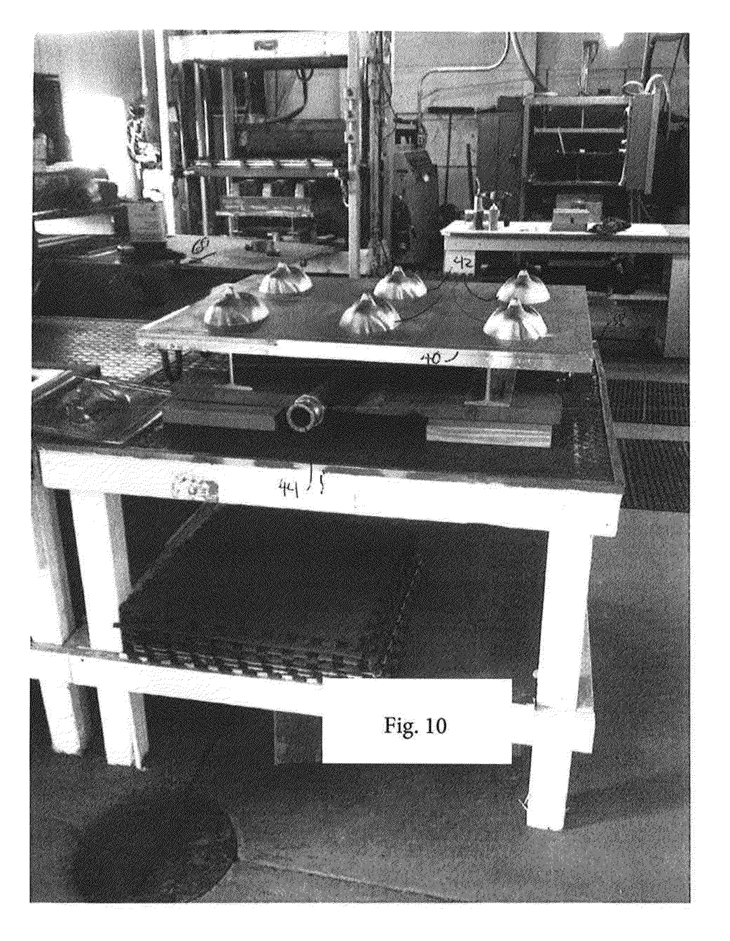

FIG. 10 is a perspective view of the master mold 40. The cold water ports 58 which include both an intake and exhaust port for circulating cold water during the later stages of the production cycle are located on the right side of the master mold 40. The cold water circulates through the entire master mold 40 and is facilitated by loop connectors 60 so that the cold water is distributed evenly throughout the master mold 40. This is necessary as one of the final production steps to cool down the thermoplastic sheet so that it to regain its room temperature rigidity.

While the present invention has been illustrated and described with reference to exemplary embodiments thereof, various modifications will be apparent to and might readily be made by those skilled in the art without departing from the scope and spirit of the present invention. Accordingly, it is not intended that the scope of the claims appended hereto be limited to the description as set forth herein, but, rather, that the claims be broadly construed.

I claim:

1. A three-dimensional dry erase board comprising:
a three dimensional erasable relief surface fabricated from a suitable material to receive ink from a dry erase board marker;
wherein images, logos, text and the like may be drawn onto the relief surface.

2. A three-dimensional dry erase board as in claim 1 and further comprising:
a flat surface fabricated from a suitable material to receive ink from a dry erase board marker; and the flat surface being adjacent to the relief surface;
wherein images, logos, text and the like may be drawn onto the flat surface.

3. A process for fabricating the three-dimensional dry erase board in claim 1 comprising:
creating a mold of a desired three-dimensional surface; the mold further comprising a vacuum circuit and a cooling circuit; heating a thermoplastic sheet to an appropriate temperature; laying the sheet on top of the master mold; applying the vacuum circuit to the space between the mold upper surface and the thermoplastic sheet; causing the thermoplastic sheet to conform to the shape of the master mold; applying a cold source to the master mold cooling circuit so as to remove any residual heat energy from the mold and thermoplastic sheet; removing the thermoplastic sheet from the mold and cutting the sheet into a finished products.

4. A method of using a three-dimensional dry erase board comprising the steps of:
drawing on the three-dimensional erase board using an erasable marker to produce a first artistic creation;
erasing the first artistic creation from the three-dimensional erase board; and then
drawing on the three-dimensional erase board using an erasable marker to produce a second artistic creation.

5. A method of using a three-dimensional dry erase board according the claim 4, wherein:
the erase board has three-dimensional features representing person, objects, logos, text, scenery or the like; and
the steps of drawing comprise drawing over the three-dimensional features with a dry erasable marker to produce an artistic creation adding dimension or character to the three-dimensional features.
